(19) United States
(12) Patent Application Publication
(10) Pub. No.: US 2021/0321823 A1
(43) Pub. Date: Oct. 21, 2021

(54) BATCH FRYER WITH A BOOSTER PUMP

(71) Applicant: Rosenqvists Food Technologies AB, Kristianstad (SE)

(72) Inventor: Magnus KALLING, Fjalkinge (SE)

(21) Appl. No.: 17/271,952

(22) PCT Filed: Aug. 30, 2019
(86) PCT No.: PCT/SE2019/050817

§ 371 Date: Feb. 26, 2021

(30) Foreign Application Priority Data
Aug. 31, 2018 (SE) 1851038-8

(51) Int. Cl. A47J 37/12; A23L 5/10; A23L 19/18

(52) U.S. Cl. CPC A47J 37/1233; A47J 37/1214; A47J 37/1276; A47J 2202/00; A23L 5/11; A23L 19/18; A23V 2002/00; A47J 37/1266

(57) ABSTRACT

A batch fryer for kettle manufacturing of deep fried food stuff comprising: an elongated cooking trough for holding a volume of cooking oil; an infeed provided at an infeed end of the elongated cooking trough for receiving food stuff; an oil circulation system comprising an oil inlet circuit and an oil outlet circuit connected to the trough for recirculation of the cooking oil in the trough; a circulation pump configured to pump oil through the oil circulation system; a heat exchanger connected to the circulation system configured to heat the cooking oil flowing through the heat exchanger from the oil outlet circuit to provide heated cooking oil to the trough via the oil inlet circuit; a booster oil inlet circuit connected to a booster pump configured to pump heated cooking oil into the trough through a booster oil inlet arranged in a wall at the proximal end of the trough at the beginning of a batch deep-frying process of food stuff.

### TECHNICAL FIELD

The present invention relates to a batch fryer and method for kettle manufacturing of deep fried food stuff.

### BACKGROUND

Kettle-style potato chips or kettle chips are typically cooked in a batch fryer. A batch of potato slices are rapidly poured into a kettle containing hot oil, after which the slices are allowed to be deep fried in the hot oil until the moisture originally contained in the potato slices has reached a desired level. Thereby, kettle-style potato chips are firmer and crunchier than chips cooked by traditional frying.

WO 2011/109495 describes a batch cooker for manufacturing of kettle-style chips. The batch cooker comprises a cooking trough, a removal belt, an infeed located at an opposite end of the trough as compared to the removal belt, a stirrer, which comprises a paddle means and which is movable along the length of the trough.

For manufacturing of kettle chips, a batch of sliced potato is fed into the trough, through the infeed. During the feeding, the stirrer may be located close to the infeed, such that the potato slices are evenly distributed in the trough. Initially, the trough is filled with high temperature oil.

The amount and quality of kettle chips that may be produced in a batch cooker depends on the operation of individual parts of the batch cooker and the joint action of the different parts. One crucial part of the overall throughput is the infeed to the cooking trough. With reference to WO 2011/109495, feedstock, such as raw potato slices, is introduced into heated cooking oil in the cooking trough via the infeed. The infeed may be a slidable, rotatable, or other type of opening mechanism. The infeed can also be interfaced with a conveyor belt, to provide high speed and automated input of feedstock into the batch cooker. The stirrer may be located close to the infeed, such that the potato slices are evenly distributed in the trough.

However, high speed input of feedstock into the batch cooker may cause accumulation of potato slices sticking together in the trough.

Moreover, when a large amount of foodstuff of rather low temperature is fed into the trough during a short time, the temperature of the heated cooking oil in the cooking trough will usually be reduced. The foodstuff may have a temperature like room temperature or even lower temperature if the foodstuff has been stored in a refrigerator close before it is to be deep-fried. As a result, the heated oil in the trough will be considerably reduced which will change the whole deep-frying process and thereby having a negative effect of the expected texture and taste of the final product, i.e the potato chips or similar deep-fried food-stuff.

U.S. Pat. No. 5,085,137 describes production of potato chips and other food products prepared by deep-fat frying, and is particularly concerned with a continuous frying method and apparatus for making potato chips which are similar in taste and texture to those produced by the slow-cooked batch or kettle process.

Peeled whole potatoes are delivered to a slicing station for cutting the whole potatoes into slices, which are delivered to the input side of a slice washer. After washing, the potato slices are delivered by a conveyor into the entrance end of a continuous frying unit.

A first inlet port is located at the entrance end of a vessel and faces in the direction toward an exit end. Heated frying oil from a heat exchanger is supplied through a pipe and mixed with cooler oil supplied through a second pipe. The cooler oil is withdrawn directly from the exit end of the vessel and does not pass through the heat exchanger. The mixture of heated and partially cooled oil is supplied under pressure to the inlet port through a pair of manifold assemblies and a weir device. The weir device contains baffles for producing a uniform, laminar flow of oil across the width of the vessel with a minimum of turbulence. The oil expelled from the inlet port passes over a false bottom, which reduces the depth of the frying oil and thereby increases its velocity. The increased velocity of the frying oil tends to prevent the potato slices from sticking to each other and to the inside surfaces of the vessel. This is sometimes a problem at the beginning of the frying process, when the slices contain the greatest amount of water.

Although, the reduced bottom will prevent the potato slices from sticking to each other, it will provide a continuous increased velocity and reduced volume of the vessel at the entrance of the production line.

### SUMMARY

It is an object of the teachings of this application to obviate at least some of the disadvantages discussed above.

In accordance with one aspect of the present disclosure, a batch fryer for kettle manufacturing of deep fried food stuff is provided,

comprising:

an elongated cooking trough for holding a volume of cooking oil;

an infeed provided at an infeed end of the elongated cooking trough for receiving food stuff;

an oil circulation system comprising an oil inlet circuit and an oil outlet circuit connected to the trough for recirculation of the cooking oil in the trough;

a circulation pump configured to pump oil through the oil circulation system;

a heat exchanger connected to the circulation system configured to heat the cooking oil flowing through the heat exchanger from the oil outlet circuit to provide heated cooking oil to the trough via the oil inlet circuit;

a booster oil inlet circuit connected to a booster pump configured to pump heated cooking oil into the trough through a booster oil inlet arranged in a wall at the proximal end of the trough at the beginning of a batch deep-frying process of food stuff.

In some embodiments of the batch fryer, the booster pump is configured to pump heated cooking oil into the trough for 20-40 s at the beginning of the batch deep-frying process.

In some embodiments of the batch fryer, the booster pump is configured to pump heated cooking oil into the trough for 30-60 s at the end of the batch deep-frying process.

In some embodiments the batch fryer may comprise a thermo oil circulation system including a thermo oil heater for heating thermo oil, a thermo oil buffer tank in oil flow connection with said thermo oil heater for storing said heated thermo oil, and a thermo oil pump configured to pump heated thermo oil through the heat exchanger for a fast and furthermore over time sustainable heating of the cooking oil flowing through the heat exchanger.

In some embodiments, the thermo oil heater is configured to heat the thermo oil in response to a temperature signal from a first temperature sensor arranged to measure the temperature of the heated thermo oil.

In some embodiments the thermo oil pump is configured to pump heated thermo oil through the heat exchanger for heating cooking oil flowing through the heat exchanger further to the trough during the batch deep-frying process, via the oil inlet circuit and the oil inlets spaced along the bottom of the through.

In some embodiments, the booster pump is configured to be activated to operate for a short time at the end of the batch deep-frying process for outputting deep-fried food stuff at the end of the batch deep-frying process.

In some embodiments of the batch fryer, the booster pump is configured to pump heated cooking oil into the trough for 35-60 s at the end of the batch deep-frying process.

In some embodiments, the batch fryer may comprise a perforated inlet plate arranged at the booster oil inlet, wherein the inlet plate is provided with numerous through holes and collars on top and bottom for laminar flow and minimizing scum generation at the beginning of the batch deep-frying process.

In some embodiments, the batch fryer may comprise a stirring assembly arranged to be moved along the trough for agitating and direct the movement of the foodstuff in the heated cooking oil in the trough during the batch deep-frying process.

In some embodiments, the stirring assembly comprises a frame, two rotatable lower shafts, each carrying a number of radial spokes for agitating the foodstuff in the trough.

In some embodiments, the spokes of the rotatable lower shafts may be made of peek.

In some embodiments, the batch fryer comprises a thermo oil circulation system including a thermo oil heater in fluid connection with a thermo oil buffer arranged to hold heated thermo oil, wherein the thermo oil buffer is in fluid connection with the heat exchanger for heating the cooking oil flowing through the heat exchanger.

In accordance with one aspect of the present disclosure, a method for batch wise manufacturing of deep-fried foodstuff using a batch fryer is provided, comprising the steps of:

filling the trough with heated cooking oil;

positioning the stirring assembly close to the inlet;

feeding a batch of foodstuff through the inlet;

booster pump heated cooking oil through the booster oil inlet;

deep frying the foodstuff in the oil for a predetermined time; and

emptying the trough from deep fried foodstuff.

In some embodiments, the step of deep frying the foodstuff, traversing the stirring assembly over the length of the trough several times under slight rotation of the lower shafts with the spokes for distributing the foodstuff in the cooking oil of the trough.

In some embodiments, the step of emptying the trough comprises booster pumping at the end of the batch deep-frying process for speeding up the outfeed.

One purpose of the teachings of this application including the booster pump is to increase the feed rate in the beginning of the frying process. The booster pump pumping heated oil will prevent the heated cooking oil in the trough to fall in a way that the characteristics, such as texture, humidity, and/or taste, of the final product will be negatively affected. Additionally, the teachings of this application prevents accumulation of potato slices sticking together at the infeed end of the trough in the beginning of the frying process when the trough is filled with feedstock, such as raw potato slices.

Another purpose of the teachings of this application is to speed up the outfeed rate at the end of the batch deep-frying process.

Other aspects and features of the invention and its embodiments are defined by the appended patent claims and are further explained, together with problems solved and advantages obtained, in the detailed description section as well as in the drawings.

It should be emphasized that the term “comprises/comprising” when used in this specification is taken to specify the presence of stated features, integers, steps, or components, but does not preclude the presence or addition of one or more other features, integers, steps, components, or groups thereof.

All terms used in the claims are to be interpreted according to their ordinary meaning in the technical field, unless explicitly defined otherwise herein. All references to “a/an/the [element, device, component, means, step, etc are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

Exemplary embodiments is illustrated by way of example in the accompanying drawings in which like reference numbers indicate the same or similar elements and in which:

FIG. 1 is a cross-sectional view showing a batch fryer according to a first embodiment for kettle manufacturing of deep fried food stuff;

FIG. 2A is a perspective view of a batch fryer with a closed hood according to a second embodiment for kettle manufacturing of deep fried food stuff;

FIG. 2B is a perspective view of the batch fryer as shown in FIG. 2A with an open hood;

FIG. 3 is a flowchart of a method for batch wise manufacturing of deep fried foodstuff according to an embodiment; and

FIG. 4 is a cross-sectional view showing a batch fryer according to a second embodiment for kettle manufacturing of deep fried food stuff;

### DESCRIPTION OF EMBODIMENTS

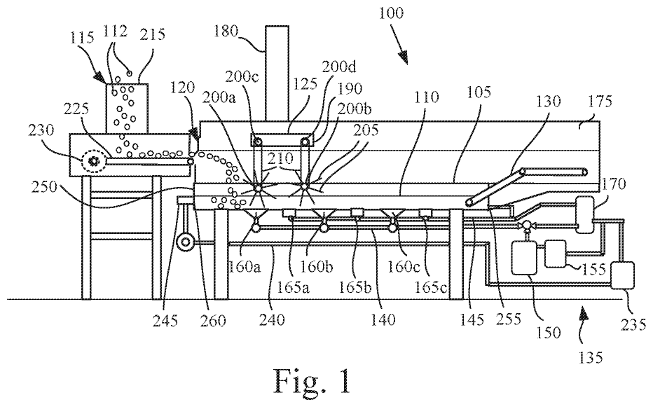

Embodiments of the invention will be described with reference to FIGS. 1-4. In cooperation with attached drawings, the technical contents and detailed description of the present invention are described thereinafter according to a preferable embodiment, being not used to limit its executing scope. Any equivalent variation and modification made according to appended claims are covered by the claims.

Reference will now be made to the figures to describe the embodiments in detail. The same reference signs are used for corresponding features in different figures.

Reference is made to FIG. 1, which is a batch fryer 100 for kettle manufacturing of deep fried foodstuff in accordance with a first embodiment. The batch fryer comprises an elongated cooking trough or vessel 105 for holding a volume of cooking oil 110 up to a desired level, or any fluid suitable for cooking foodstuff. The foodstuff may include but is not limited to raw potato slices 112 fried into kettle chips, fruit slices or slices of different kinds of vegetables.

An infeed delivery arrangement 115 is provided for feeding the raw potato slices 112 via an infeed 120 to the cooking trough 105. A stirring assembly 125 is arranged to be moved along the trough for agitating and direct the movement of the potato slices in the heated cooking oil in the trough 105 during the deep-frying process. Deep-fried kettle chips are removed form the cooking trough 105 by an outfeed conveyor belt 130.

The cooking oil is provided to the cooking trough 105 by a cooking oil circulation system 135 including an oil inlet circuit 140 with pipes and an oil outlet circuit 145 with pipes connected to a heat exchanger 150 for heating the cooking oil, i.e vegetable oil, outside the cooking trough. Heated cooking oil is fed to the cooking trough 105 by a circulation pump 155 of the oil circulation system 135 via the oil inlet circuit 145 through a plurality of oil inlets 160a; 160b; 160c, which are arranged in the bottom of the cooking trough 105. Oil is removed from the trough 105 by the pump 155 through oil outlets 165a; 165b; 165c and filtered by a cooking oil filter 170, preferably but not limited to a drum filter, arranged outside the batch fryer. The filter 170 is part of the oil circulation system 135 and may be connected between the oil outlet circuit 145 and the pump 155. The batch fryer includes a hood 175 with an exhaust pipe 180.

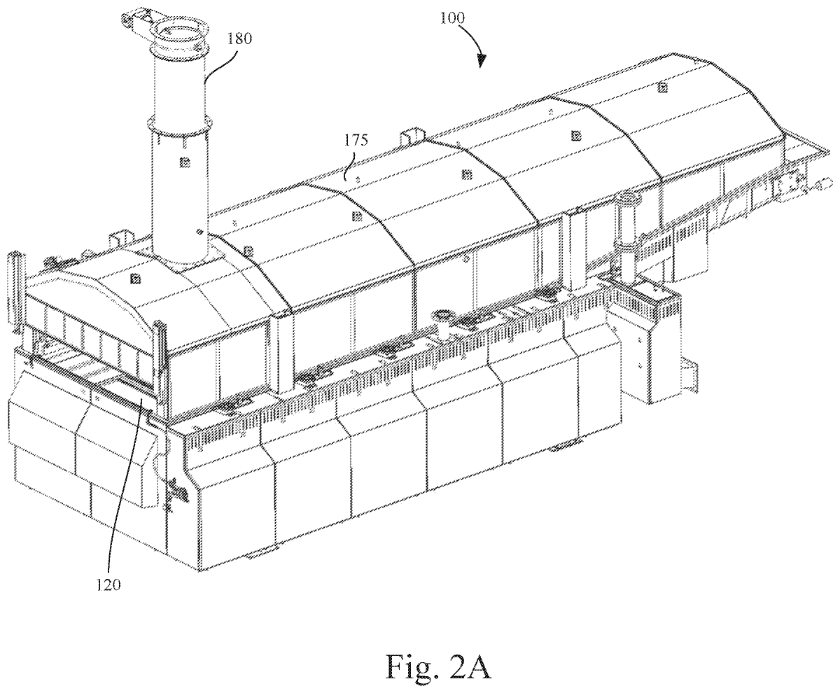

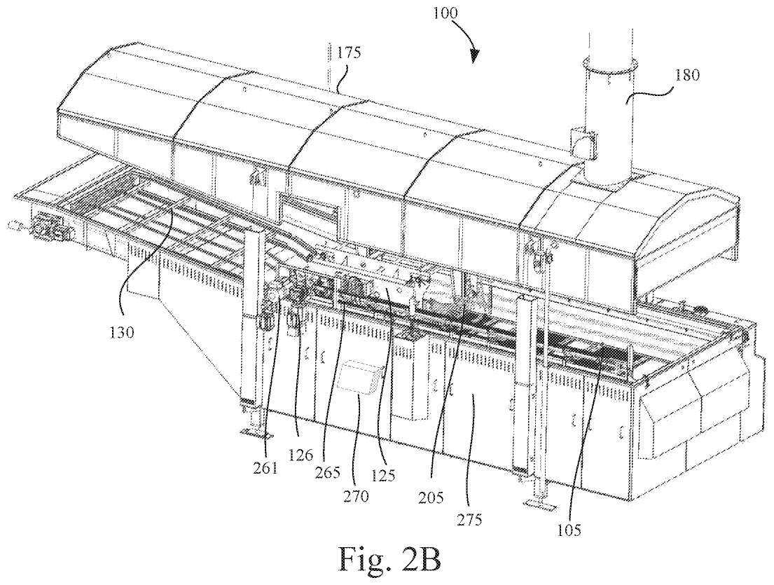

The hood 175 is vertically movable between a lower closed position, as shown in FIG. 2A, and an upper open position as shown in FIG. 2B.

With reference to FIG. 1, the stirring assembly 125 may comprise a frame 190, two rotatable lower shafts 200a, 200b, each carrying a number of radial spokes 205 for agitating the foodstuff in the trough. The spokes 205 of the rotatable lower shafts 200c, 200d may be made of solid peek to reduce sticking of foodstuff, such as potato slices, and to avoid the potato slices to be damaged or broken into splinters by the spokes.

The stirring assembly 125 can be moved along the length of the trough 105 by means of a propulsion arrangement preferably arranged outside the hood and trough, including e.g chain drives, electrical drive means, hydraulic actuators or the like. In one embodiment, an electrical motor 126, as shown in FIG. 2B, is arranged to provide rotational energy to upper shafts 200c, 200d, connected to and driving the lower shafts 200a, 200b by chains 210 and sprockets for agitating the potato slices/chips as well as propulsion of the stirring assembly 125 to be moved backward and forward along the trough 105.

As illustrated in FIG. 1, the infeed delivery arrangement 115 may have an intake opening 215 for receiving the foodstuff 112 to be deep-fried in the batch fryer. One example of foodstuff is raw potato slices. Other foodstuff, for example vegetables or fruits, may be deep-fried by the batch fryer. An infeed conveyor belt 225, driven by an electrical motor 230, is arranged for high speed delivery of raw potato slices 112 through the infeed 120 into the batch fryer for deep-frying in the heated cooking oil 110 in the trough 105.

In operation, the shafts 200a, 200b of the stirring assembly 125 may be rotated in the same direction or counter-rotated relative to each other. In one embodiment, the spokes 205 may be attached to the shafts 200a, 200b in regular or irregular rows. However, to achieve an efficient and even frying of the chips the spokes may be attached to the shafts 200a, 200b in a continuous helix pattern along the shafts.

The oil circulation system 135 includes a second circulation pump, a booster pump 235, driven by a motor. The booster pump 235 is configured to pump heated cooking oil from the heat exchanger 150 via the filter 170, which may be mixed with oil from the trough, through a booster oil inlet circuit 240 with pipes of the oil circulation system 135 to a booster oil inlet 245 arranged at an infeed end wall 250 of the cooking trough 105 below the infeed 120.

One purpose of the booster pump 235 is to increase the feed rate. Thus, more products, such as potato slices, can be cut down and fed into the trough 105 more quickly. When a large amount of foodstuff of rather low temperature is fed into the trough 105 during a short time, the temperature of the heated cooking oil 110 in the cooking trough 105 will usually be reduced. The foodstuff may have a temperature like room temperature or even lower temperature if the foodstuff has been stored in a refrigerator close before it is to be deep-fried. As a result, the heated oil in the trough will be considerably reduced which will change the whole deep-frying process and thereby having a negative effect of the expected texture and taste of the final product, i.e the potato chips or similar deep-fried food-stuff.

The booster pump 235 may be configured to be activated to operate for a short time at a relatively high speed at the beginning of the batch deep-frying process, thereby enabling an increased infeed of the foodstuff by the infeed delivery arrangement 115 and infeed conveyor belt 225 into the through of the batch fryer. After the foodstuff 112 have been fed into the batch fryer and spread out at the entrance part of the through by means of the booster pump 235, the booster pump 235 is stopped or the speed of the pump is at least considerably reduced. Then, the batch deep-frying process continues. At the end of the deep-frying process, i.e about, but not limited to, 7 minutes, the booster pump 235 may be activated once again for withdrawing oil and scum, produced as residue during the deep-frying process, through the oil outlet 255.

Operation of the booster pump 235 for increasing vegetable oil temperature in the pan fast and spreading out the potato slices at the beginning of the batch deep-frying process prevents the slices from sticking to each other even at a high infeed rate.

A perforated inlet plate 260 is arranged at the booster oil inlet 245. The inlet plate 260 is provided with numerous through holes and collars on top and bottom causing laminar flow and minimizing scum generation at the beginning of the batch deep-frying process. By minimizing the amount of scum at the beginning as well as to remove the scum generated during the process, the amount of peroxide and free fat acids in the cooking oil 110 in the trough 105 are advantageously reduced.

Reference is made to FIG. 2B, which is a perspective view of batch fryer as shown in FIG. 2A with an open hood 175. A drive motor 261 is arranged on the batch fryer 100 outside the hood 175 to drive the stirring assembly 125 back and forth along the trough 105 by means of a screw axial drive 265.

A control system, which may comprise circuitry and/or a program-control device 270 is configured to run the operation of the batch fryer 100. The circuitry and/or a program-control device 270 may be located within a cabinet 275 of the batch fryer and is operatively connected to and configured to control the operation of the booster pump 235 according the method described below. Further, the circuitry and/or a program-control device 270 may be operatively connected to and configured to control the operation of the oil circulation system 135 including the oil inlet circuit 140 and an oil outlet circuit 145, and the heat exchanger 150. As describe above, heated cooking oil is provided to the cooking trough 105 by the circulation pump 155, which may also be controlled by the circuitry and/or a program-control device 270. The drive motor 261 for driving the stirring assembly 125 may also be operatively connected to and controlled by the circuitry and/or a program-control device 270.

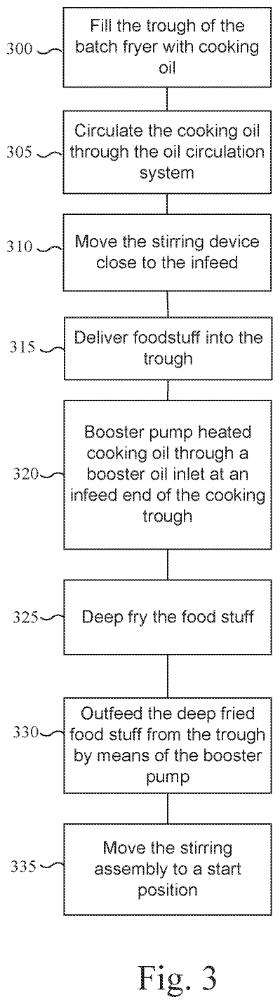

Reference is made to FIG. 3, which is a flowchart of a method for batch wise manufacturing of deep fried foodstuff according to an embodiment. The method may involve a batch fryer according to the present disclosure.

Initially, the trough is filled 300 with cooking oil 110 to the desired level and the cooking oil is circulated 305 by means of the oil circulation system 135. The cooking oil is withdrawn from the trough 105 through oil outlet circuit 145 by means of the pump 155 before it is reheated to a determined temperature by the heat exchanger 150 and forwarded via the oil inlet circuit 140 through the oil outlets 165a; 165b; 165c. The stirring device 125 is positioned 310 rather close to the infeed end wall 250 in the trough 105 and with rotating shafts 200a-d.

The food stuff, i.e the raw potato slices 112, is delivered 315 through the intake opening 215 into the infeed arrangement 115, wherein the potato slices fall down on the belt conveyor 225, for high speed delivery through the infeed 120 into the heated cooking oil 110 in the trough 105. The foodstuff to be deep fried will fall into the oil in the space between the stirring assembly 125 and the infeed end wall 250 to the left of the trough. During the infeed of the batch of foodstuff, which lasts for about 20-40 seconds, preferably about 30 seconds, the booster pump 235 will operate and pump 320 heated cooking oil from the heat exchanger 150, which may be mixed with oil from the trough 105, through the booster oil inlet 245 into the cooking trough 105. Thereby, the infeed rate will be increased and potato slices (or other food stuff) 112 are advantageously spread out at the entrance part of the through.

The temperature of the cooking oil is dropped when the potato slices are fed into the trough. In order to cook kettle-style chips with desirable characteristics, such as taste and crisp, the cooking oil should have a desired temperature profile, preferably following the inverse bell curve over a period of time, approximately but not limited to about 300 s. The temperature profile may be controlled by pumping reheated cooking oil delivered by the pump 155. The moisture in the sliced potatoes will vaporize. After the initial temperature drop, the oil temperature may be kept rather constant, such that the remaining moisture in the sliced potatoes/chips is boiled off. The stirring assembly will be moved back and forth over the length of the trough 105, wherein the sliced potatoes will be mixed.

After the infeed of foodstuff, the foodstuff will get deep fried 325 in the oil for a few minutes, approximately 7-8 minutes. During this period, the stirring assembly 125 will traverse back and forth over the length of the trough several times under slight rotation of the shafts 200a, 200b with the spokes 205 since it is desired that the foodstuff is pushed down under the oil surface from time to time.

After the moisture reducing step and the foodstuff has been deep fried to a certain desired degree, the trough is emptied from deep fried foodstuff, i.e potato chips, and the oil temperature is increased by operating the booster pump 235 to provide additional reheated oil into the trough. The fryer is emptied 330 from deep fried foodstuff by rotating the shafts 200a, 200b in a counter clockwise direction such that the foodstuff is forced to the outfeed belt 130, which is activated at the end of the deep fired process, while also moving the entire stirring assembly in a direction toward the outfeed belt. This will force the entire potato slice batch towards the outfeed belt 130 for outfeed.

In addition to the running outfeed conveyor belt 130, the booster pump 235 is operated for accelerating the outfeed. Hence, the booster pump may be operated for 30-60 s, preferably about 45 s, at the end of the batch deep-frying process. The stirring assembly 125 is moved 335 to a start position to the left of the trough as shown in FIG. 1, i.e still with space between the stirring assembly 125 and the infeed end wall 250 to the left of the trough.

The foodstuff that exits the fryer after having been deep fried may be subject to seasoning/drying and/or other post-fry processes before being packaged for delivery to end consumers.

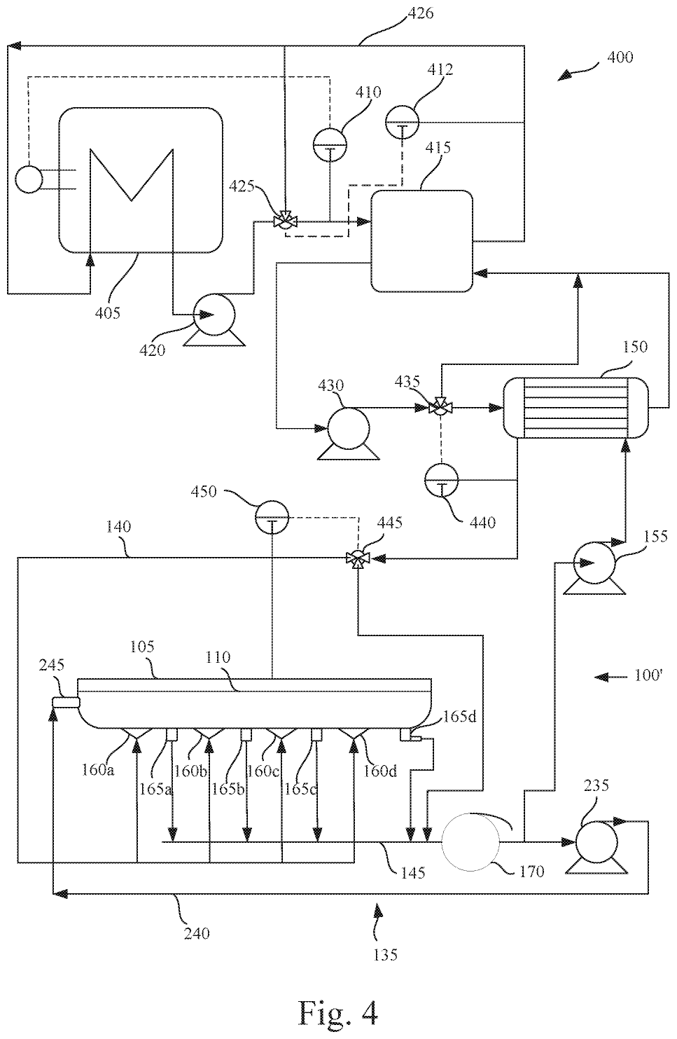

Reference is made to FIG. 4, which is a batch fryer 100′ for kettle manufacturing of deep fried food stuff in accordance with a second embodiment.

The batch fryer 100′ may comprise all features of the first embodiment described in conjunction with FIG. 1. However, the embodiment shown in FIG. 4 illustrates the oil circulation system 135 in further detail and in connection with a thermo oil circulation system 400. As described above, the oil circulation system 135 includes, but is not limited to, the oil inlet circuit 140 and oil outlet circuit 145 connected to a heat exchanger 150 for heating the cooking oil outside the cooking trough. Heated cooking oil is fed to the cooking trough 105 by the circulation pump 155 of the oil circulation system 135 via the oil inlet circuit 145 through the plurality of oil inlets 160a; 160b; 160c; 160d arranged in the bottom of the cooking trough 105. Cooking oil is removed from the trough 105 by the pump 155 through the oil outlets 165a; 165b; 165c; 165 and filtered by the cooking oil filter 170, preferably but not limited to a drum filter, arranged outside the batch fryer. The filter 170 is part of the oil circulation system 135 and may be connected between the oil outlet circuit 145 and the pump 155.

The oil circulation system 135 includes a second circulation pump, a booster pump 235, driven by a motor. The booster pump 235 is configured to pump heated cooking oil from the heat exchanger 150 via the filter 170 through a booster oil inlet circuit 240 of the oil circulation system 135 to a booster oil inlet 245 arranged at an infeed end wall 250 of the cooking trough 105 below the infeed 120. The heated cooking oil from the heat exchanger 150 may be mixed with oil from the trough.

As describe above, one purpose of the booster pump 235 is to increase the feed rate. Thus, more products, such as potato slices, can be cut down and fed into the trough 105 more quickly. However, when a large amount of foodstuff of rather low temperature is fed into the trough 105 during a short time, the temperature of the heated cooking oil 110 in the cooking trough 105 will usually be reduced. The foodstuff may have a temperature like room temperature or even lower temperature if the foodstuff has been stored in a refrigerator close before it is to be deep-fried. As a result, the heated oil in the trough will be considerably reduced which will change the whole deep-frying process and thereby having a negative effect of the expected texture and taste of the final product, i.e the potato chips or similar deep-fried food-stuff. Hence, the desired U-shaped temperature-time profile of the food-stuff cooked in the batch fryer may be changed.

A thermo oil circulation system 400 with pipes may be connected to the heat exchanger 150 in order to provide a fast heating of the vegetable oil in the cooking oil circuit 135, especially at the beginning of the batch process. The heated oil is fed to the booster oil inlet circuit 240 of the oil circulation system 135 to the booster oil inlet 245 arranged at the infeed end wall 250 of the cooking trough 105 below the infeed 120. The thermo oil circulation system 400 may comprise, but is not limited to a thermo oil heater 405 operatively connected to an output of a first temperature sensor 410 for controlling the operation of the thermo oil heater 405 for heating the thermo oil in the thermo oil heater. The heated thermo oil is fed from the thermo oil heater 405 to a thermo oil buffer or tank 415 by means of a first thermo oil pump 420 via a first three way valve 425. A temperature of the thermo oil from the three way valve 425 is detected/measured by the first temperature sensor 410 for controlling the operation of the thermo oil heater to heat the thermo oil to a desired temperature. The thermo oil buffer 415 is in flow connection with the thermo oil heater 405 via a thermo oil feedback conduit 426, which is also branch connected to an input of the three way valve 425. The three way valve 425 is arranged to be controlled in response to an output from a second temperature sensor 412, detecting the temperature of the thermo oil flowing through the feedback conduit 426. Thereby, the three way valve can be operated to either feed thermos oil form the thermo oil heater 405 or recirculate thermo oil of the thermos oil buffer. The thermo oil buffer 415 may hold a large amount, about 4000 l, of heated thermo oil at a temperature about 210-260° C. A second temperature sensor 412 is connected to

The heated thermo oil is fed from the buffer 415 through the heat exchanger 150 by means of a second thermo oil pump 430 and a second three way valve 435. The second three way valve is controlled by a third temperature sensor 440, which operates in response to the temperature of the vegetable oil output from the heat exchanger 150. The thermo oil will have a temperature of about 190° C. from the second thermo oil pump 430. The heat exchanger 150 may be of about, but not limited to, 800 kW. In order to provide the required amount of thermo oil at a desired temperature, the second three way valve 435 may be controlled to recirculate heated oil back into the thermo oil buffer 415. Thereby, the required amount of energy/power for heating the thermo oil in the buffer is reduced.

The heated vegetable cooking oil, which has been heated by means of flowing through the heat exchanger 150, may be fed into the through 105 via third three way valve 445, which is controlled by a fourth temperature sensor 450, the filter 170 through the booster oil inlet circuit 240 with the of the oil circulation system 135 to the booster oil inlet 245 for a fast heating of the cooking oil in the trough 105 at the beginning of the batch process. Hence, the thermo oil circulation system 400, including the thermo oil buffer 415 in combination with the booster oil inlet circuit 240 with the booster pump 235, provide a more steep temperature profile of the cooking oil in the through 105 at the beginning of the batch process. Additionally, the thermo oil circulation system 400 and the booster pump 235 enable increased adjustment of the temperature profile of the cooking oil during the batch process.

The third temperature sensor 445 is configured to control the third three way valve 450 to fed not only the booster oil inlet circuit at the beginning of the batch process but also the oil infeed via the oil inlets 160a; 160b; 160c; 160d during the whole batch process.

Advantageously, the time for the overall batch process will be reduced with the same or increased quality of the final product, i.e batch cooked food stuff, such as potato chips, fruit slices or slices of different kinds of vegetables.

As described above, the circuitry and/or a program-control device 270 is configured to run the operation of the batch fryer 100. Additionally, the components of the thermo oil circulation system, including, but not limited to, the thermo oil heater 405, the first, second, third and fourth temperature sensors 410, 412, 440, and 450, the first thermo oil pump 420, the first, second, and third three way valves 425, 435, and 445, and the second thermo oil pump 430, are operatively connected to and controlled by the circuitry and/or a program-control device 270.

Embodiments of the present invention have been described herein with reference to a batch deep-frying process and the operation of a batch fryer. It will be understood that the control of the operation of the batch fryer and the method of batch wise manufacturing of deep fried foodstuff may be implemented in the form of an entirely hardware embodiment, such as the circuitry and/or a program-control device 270, or an embodiment combining software and hardware aspects including computer program instructions to control the different components and systems of the batch fryer. These computer program instructions may be provided to a processor of the program-control device, a general purpose computer, special purpose computer, or other programmable data processing apparatus of the batch fryer, such that the instructions when executed create means for implementing the specified functions/acts of the batch frying process to operate the batch fryer accordingly.

1. A batch fryer for kettle manufacturing of deep fried food stuff comprising:
an elongated cooking trough for holding a volume of cooking oil;
an infeed provided at an infeed end of the elongated cooking trough for receiving food stuff;
an oil circulation system comprising an oil inlet circuit and an oil outlet circuit connected to the trough for recirculation of the cooking oil in the trough;
a circulation pump configured to pump oil through the oil circulation system;
a heat exchanger connected to the circulation system configured to heat the cooking oil flowing through the heat exchanger from the oil outlet circuit to provide heated cooking oil to the trough via the oil inlet circuit;
characterized by a booster oil inlet circuit connected to a booster pump configured to pump heated cooking oil into the trough through a booster oil inlet arranged in an infeed end wall of the cooking trough below the infeed at the beginning of a batch deep-frying process of food stuff.

2. The batch fryer of claim 1, wherein the booster pump is configured to pump heated cooking oil into the trough for 20-40 s at the beginning of the batch deep-frying process.

3. The batch fryer according to any of the previous claims, of claim 1, comprising a thermo oil circulation system including a thermo oil heater for heating thermo oil, a thermo oil buffer tank in oil flow connection with said thermo oil heater for storing said heated thermo oil, and a thermo oil pump configured to pump heated thermo oil through the heat exchanger for a fast heating of the cooking oil flowing through the heat exchanger.

4. The batch fryer according to claim 3, wherein the thermo oil heater is configured to heat the thermo oil in response to a temperature signal from a first temperature sensor arranged to measure the temperature of the heated thermo oil.

5. The batch fryer according to claim 3, wherein the thermo oil pump is configured to pump heated thermo oil through the heat exchanger for heating cooking oil flowing through the heat exchanger further to the troughs during the batch deep-frying process, via the oil inlet circuit and the oil inlets spaced along the bottom of the through.

6. The batch fryer according to any of the claim 1, wherein the booster pump is configured to be activated to operate at the end of the batch deep-frying process for outputting deep-fried food stuff from the trough.

7. The batch fryer of claim 6, wherein the booster pump is configured to pump heated cooking oil into the trough for 30-60 s at the end of the batch deep-frying process.

8. The batch fryer according to claim 1, comprising a perforated inlet plate arranged at the booster oil inlet, wherein the inlet plate is provided with numerous through holes and collars on top and bottom for laminar flow and minimizing scum generation at the beginning of the batch deep-frying process.

9. The batch fryer according to claim 1, comprising a stirring assembly arranged to be moved along the trough for agitating and direct the movement of the foodstuff in the heated cooking oil in the trough during the batch deep-frying process.

10. The batch fryer according to claim 9, wherein the stirring assembly comprises a frame, two rotatable lower shafts, each carrying a number of radial spokes for agitating the foodstuff in the trough.

11. The batch fryer according to claim 10, wherein the spokes of the rotatable lower shafts are made of peek.

12. The batch fryer according to claim 1, comprising a thermo oil circulation system including a thermo oil heater in fluid connection with a thermo oil buffer arranged to hold heated thermo oil, wherein the thermo oil buffer is in fluid connection with the heat exchanger for heating the cooking oil flowing through the heat exchanger.

13. A method for batch wise manufacturing of deep-fried foodstuff using a batch fryer according to claim 1, comprising the steps of:
filling the trough with heated cooking oil;
positioning the stirring assembly close to the inlet;
feeding a batch of foodstuff through the inlet;
booster pumping heated cooking oil through the booster oil inlet at the beginning of the batch deep-frying process;
deep frying the foodstuff in the oil for a predetermined time; and
emptying the trough from deep fried foodstuff.

14. The method according to claim 13, wherein the step of deep frying the foodstuff, traversing the stirring assembly over the length of the trough several times under slight rotation of the lower shafts with the spokes for distributing the foodstuff in the cooking oil of the trough.

15. The method according to claim 13, wherein the step of emptying the trough comprises booster pumping at the end of the batch deep-frying process for speeding up the outfeed.
